(19) United States
(12) Patent Application Publication
(10) Pub. No.: US 2008/0094253 A1
(43) Pub. Date: Apr. 24, 2008

(54) Information Transmitting Device, Information Processing System, Mobile Phone, and Program

(75) Inventor: Takumi Ikeda, Hyogo (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/569,267

(22) PCT Filed: May 16, 2005
(86) PCT No.: PCT/JP05/08865

§ 371 Date: Nov. 17, 2006

(30) Foreign Application Priority Data
May 19, 2004 (JP) 2004-148651

(51) Int. Cl. G08G 1/01; H04M 1/00

(52) U.S. Cl. 340/936; 455/550.1

(57) ABSTRACT

An information processing system equipped with a detecting device, information transmitting device, and operating device. The detecting device transmits a moving state of a mobile object, detected. The information transmitting device includes an information storage part storing information; an obtaining part for obtaining a moving state of a mobile object; and an information transmitting part that changes a range for transmitting the information according to the moving state, to transmit the information. The operating device receives information from the transmitting device to operate according to the information received. This system allows timely operation of an operating device that operates according to information received from the information transmitting device moving relatively to the operating device.

### TECHNICAL FIELD

The present invention relates to an information transmitting device, information processing system, and the like, that change a range for transmitting information, according to their moving state such as speed or acceleration.

### BACKGROUND ART

As a conventional technology, Bluetooth (registered trademark) is known. The technology is a wireless communication standard aimed at power saving and short range, with its transmission range of approximately 10 m at a transmission power level of 1 mW. A document describes that the transmission range is extended to a maximum of 100 m by increasing the transmission power level (document name: An Introduction of Bluetooth, New Computer Technology Library (in Japanese), pp. 28-35, first edition, Jan. 13, 2001, Gijutsu-Hyohron Co., Ltd.)

However, in the above-mentioned conventional technology, a device that operates according to information received from a moving information transmitting device does not timely operate due to its transmission range not changing automatically according to a moving state such as speed or acceleration of moving.

Further, when moving at a high speed, a long communication range is not ensured, and neither is time for completing the communication process as a result.

### SUMMARY OF THE INVENTION

An information processing system according to the present invention is equipped with a detecting device, information transmitting device, and operating device. The detecting device includes a detecting part for detecting a moving state of a mobile object; and a moving state transmitting part for transmitting the moving state to the information transmitting device. The information transmitting device includes an information storage part that stores information; an obtaining part for obtaining a moving state of the mobile object; and an information transmitting part that changes the range for transmitting the information according to the moving state, to transmit the information. The operating device includes an information receiving part that receives information from the information transmitting device; and an operating part that operates according to information received by the information receiving part.

With this assembly, the operating device can timely operate according to information received from the information transmitting device moving relatively to the operating device.

Another information processing system according to the present invention is equipped with a detecting device and an information transmitting device. The detecting device includes a detecting part for detecting a moving state of a mobile object; and a moving state transmitting part for transmitting the moving state to the information transmitting device. The information transmitting device includes an obtaining part for obtaining the moving state of the mobile object; and an information transmitting part that changes the transmission range according to the moving state, to transmit sound information having been input. Such information transmitting part may transmit information for data communication, for example.

With this assembly, a long communication range is ensured when moving at a high speed, and so is time for completing the communication process as a result. Meanwhile, when moving at a low speed, communication with low power consumption is available.

The present invention provides information transmitting device and the like that automatically change the range for transmitting information according to the moving state of the mobile object.

### BRIEF DESCRIPTION OF DRAWINGS

FIG. 1 is a block diagram of an information processing system according to a first exemplary embodiment.

FIG. 2 is a flowchart showing operation of an information transmitting device according to the first exemplary embodiment.

FIG. 3 is a flowchart showing the operation of an operating device according to the first exemplary embodiment.

FIG. 4 is a conceptual diagram of the information processing system according to the first exemplary embodiment.

FIG. 5 shows a management table of information transmission modes in the first exemplary embodiment.

FIG. 6 shows a management table of information transmitting device identifiers in the first exemplary embodiment.

FIG. 7 is a block diagram of an information processing system according to a second exemplary embodiment.

FIG. 8 is a flowchart showing operation of an information transmitting device according to the second exemplary embodiment.

FIG. 9 is a conceptual diagram of an information processing system according to the second exemplary embodiment.

FIG. 10 shows a management table of information transmission modes in the second exemplary embodiment.

FIG. 11 is a block diagram of an information transmitting device according to the second exemplary embodiment.

### REFERENCE MARKS IN THE DRAWINGS

11 Detecting device
12, 72 Information transmitting device
13 Operating device
1101 Detecting part
1102 Moving state transmitting part
1201 Information storage part
1202 Obtaining part
1203 Information transmitting part
1301 Information receiving part
1302 Operating part
7203 Information transmitting part
7204 Sound accepting part
13021 Authenticating means
13022 Operating means

### DETAILED DESCRIPTION OF PREFERRED EMBODIMENTS

Hereinafter, a description is made for exemplary embodiments of the information processing system and the like with reference to related drawings. Here, a component with the same mark given in an exemplary embodiment operates in the same way, and thus a repeated description may be omitted.

### FIRST EXEMPLARY EMBODIMENT

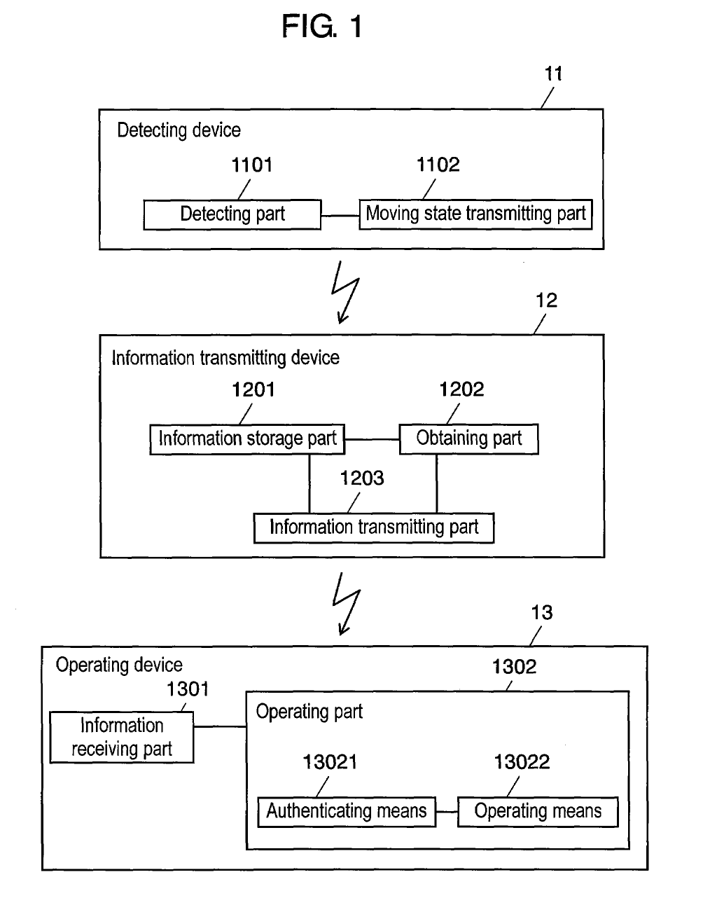

FIG. 1 is a block diagram of an information processing system according to the exemplary embodiment. The information processing system is equipped with detecting device 11, information transmitting device 12, and operating device 13. Detecting device 11 is a device for detecting a moving state such as speed or acceleration of a mobile object such as an automobile, for example. Information transmitting device 12 is a communication device placed on a mobile object such as an automobile, for example. Operating device 13 is an ETC gate, for example, placed at an expressway entrance, for example.

Detecting device 11 includes detecting part 1101 and moving state transmitting part 1102. Information transmitting device 12 includes information storage part 1201, obtaining part 1202, and information transmitting part 1203. Operating device 13 includes information receiving part 1301 and operating part 1302. Operating part 1302 includes authenticating means 13021 and operating means 13022.

Detecting part 1101 detects a moving state of a mobile object. The mobile object is a vehicle such as an automobile, bus, train, aircraft, or information transmitting device 12. A moving state refers to speed or acceleration at which a mobile object moves, information indicating a moving path of a mobile object, or the like. Detecting part 1101 detects speed of an automobile, for example. Detecting part 1101 can be implemented with a speed sensor placed on the automobile and its driver software, for example.

Moving state transmitting part 1102 transmits a moving state detected by detecting part 1101 to information transmitting device 12. Moving state transmitting part 1102, usually implemented with a wireless or wired communication means, may be implemented with a broadcasting means as well.

Information storage part 1201 stores information including information for operating device 13 to authenticate, an information transmitting device identifier for identifying information transmitting device 12, a command for operating device 13, and information for operating device 13 to display, where content, structure, and others of the information do not matter. Still, information may be received externally. Storing information in information storage part 1201 includes storing temporarily. Information storage part 1201 may be a recording medium either nonvolatile or volatile.

Obtaining part 1202 obtains a moving state of a mobile object. Obtaining includes obtaining by means of communication and reading data from a recording medium. A recording medium mentioned here may be either nonvolatile or volatile as long as the medium has a receiving function. A recording medium includes various kinds of memory cards, for example. Obtaining part 1202 receives a moving state from detecting device 11, for example. Therefore, obtaining part 1202 is implemented with a wireless or wired communication means, for example. Obtaining part 1202 may be implemented with a broadcast receiving means, for example.

Information transmitting part 1203 changes the range, in which information in information storage part 1201 is transmitted, according to a moving state obtained by obtaining part 1202, to transmit the information. Information transmitting part 1203 changes the range, in which information is transmitted, according to speed, for example, to transmit information in information storage part 1201. Information transmitting part 1203 can be implemented with a wireless communication means. Information transmitting part 1203 is a communication means conforming to the Bluetooth standards, for example. Information transmitting part 1203 changes the range for transmitting information to three levels according to speed, for example, to transmit the information. That is to say, information transmitting part 1203 classifies moving states into multiple levels, for example, and changes the transmission range according to each level to transmit the information. The changing of the range for transmitting information is implemented by transmitting the information with different electric field intensities, for example. Meanwhile, information transmitting part 1203 may be, besides Bluetooth, a communication means conforming to a standard such as Ultra-Wideband Access (3.1 GHz to 10.6 GHz), IEEE 802.11b, IrDA, Wireless 1394, or TD-CDMA. Here, information transmitting part 1203 may transmit information only when it judges that the condition for transmitting information is satisfied. For instance, information transmitting part 1203 may transmit information as a result of detecting that it is approaching an ETC gate. Approaching an ETC gate is judged by position information obtained with a GPS receiver (not illustrated) and map information (not illustrated) stored in the navigation system.

Information receiving part 1301 receives information from information transmitting device 12. Information receiving part 1301 can be implemented with a wireless communication means. Information receiving part 1301 is a communication means conforming to the Bluetooth standard, for example, or may be a communication means conforming to a standard such as Ultra-Wideband Access, IEEE 802.11b, or TD-CDMA.

Operating part 1302 operates according to information received by information receiving part 1301. Here, “operates according to information received by information receiving part 1301” means the following, for example. That is, operation is triggered by the fact that information receiving part 1301 has received information; different operation is performed according to the content of information received; or after an authentication process is performed according to information received, to be described later, operation is performed only when the authentication result is authentication admitted. “Operation” here includes various kinds of operation, and the present invention is not limited by the content of operation. The content of operation may vary according to other information and factors. The operation may be that for opening an automatic door. In this case, operating device 13 is an automatic door. The operation may be that for opening an ETC gate. In this case, operating device 13 is an ETC gate. Authenticating means 13021 performs authentication according to information received. Authenticating means 13021 performs authentication by means of the following processes, for example. That is, authenticating means 13021 stores one or more information transmitting device identifiers for identifying information transmitting device 12 to be authenticated. Authenticating means 13021 judges whether or not the information received is present in the information transmitting device identifiers stored, and if present, judges authentication admitted; otherwise, authentication denied. Alternatively, authenticating means 13021 may be a means that requests an external authentication server (not illustrated) to perform authentication and receives a result of the authentication. When requesting such authentication, authenticating means 13021 transmits information transmitting device identifier included in the information received to the authentication server. Authenticating means 13021 can be usually implemented with an MPU, memory, and the like. The processing procedure for authenticating means 13021 to authenticate is usually implemented with software, which is recorded in a recording medium such as a ROM. However, the procedure may be implemented with hardware (a dedicated circuit) as well.

Operating means 13022 operates when the authentication result by authenticating means 13021 is authentication admitted. A means for implementing operating means 13022 is different depending on the content of operation.

Hereinafter, a description is made for the operation of the information processing system. First, the operation of detecting device 11 is described. Detecting part 1101 of detecting device 11 usually detects a moving state of a mobile object always and regularly. Then, moving state transmitting part 1102 transmits a moving state detected by detecting part 1101 to information transmitting device 12. Timing for transmitting the moving state may be either every time detecting part 1101 detects a moving state, or when a given condition is satisfied. In the case where a moving state is transmitted when a given condition is satisfied, moving state transmitting part 1102 performs the process for judging whether or not the moving state satisfies the given condition.

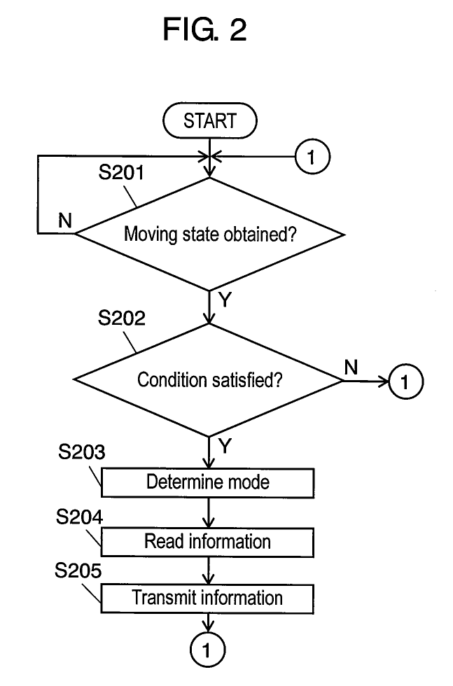

Next, a description is made for the operation of information transmitting device 12 using the flowchart of FIG. 2.
(Step S201) Obtaining part 1202 judges whether or not a moving state has been obtained. If obtained, the flow proceeds to step S202; otherwise, returns to step S201.
(Step S202) Information transmitting part 1203 judges whether or not the condition for transmitting information is satisfied. If satisfied, the flow proceeds to step S203; otherwise, returns to step S201.
   Whether or not the condition for transmitting information is satisfied is judged by whether or not the mobile object has approached within a given range from an ETC gate to be described later. For instance, such judgement is made according to position information obtained with a GPS receiver (not illustrated) and map information.
(Step S203) Information transmitting part 1203 determines the mode for transmitting information according to the moving state obtained in step S201. This mode determines the range for transmitting information. That is, the range for transmitting the information varies depending on the mode.
(Step S204) Information transmitting part 1203 reads information in information storage part 1201.
(Step S205) Information transmitting part 1203 transmits the information read in step S204 according to the mode determined in step S203. The flow returns to step S201.

In the flowchart of FIG. 2, the process ends with power off or interruption for process end.

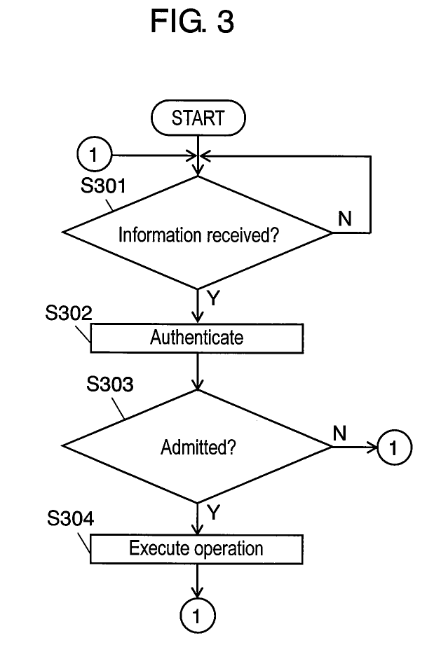

Next, a description is made for the operation of operating device 13 using the flowchart of FIG. 3.
(Step S301) Judgement is made whether or not information receiving part 1301 has received information. If judged as received, the flow proceeds to step S302; otherwise, returns to step S301.
(Step S302) Authenticating means 13021 of operating part 1302 performs authentication according to information received.
(Step S303) Operating means 13022 of operating part 1302 judges whether or not the authentication result by authenticating means 13021 is authentication admitted. If authentication admitted, the flow proceeds to step S304; otherwise returns to step S301.
(Step S304) Operating means 13022 operates. The flow returns to step S301.

Here, in the flowchart of FIG. 3, the process ends with power off or interruption of input of a signal for directing process end.

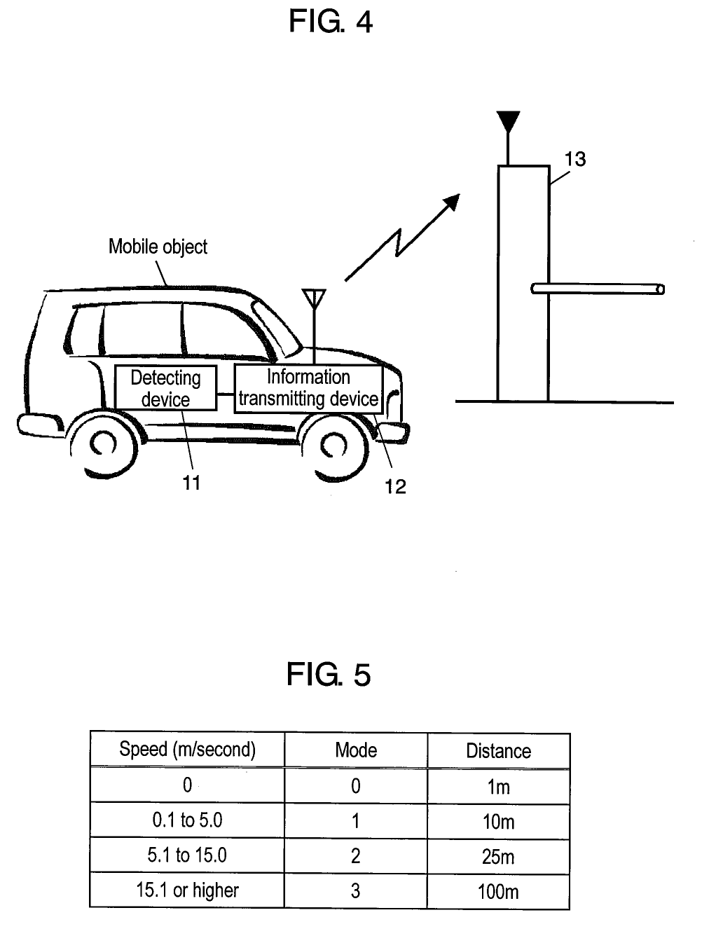

Hereinafter, a concrete description is made for an information processing system according to the embodiment. FIG. 4 is a concrete conceptual diagram of the information processing system. In this system, the mobile object is an automobile. In this system, the automobile transmits an identifier for the automobile (or for the information transmitting device) to an ETC gate, and the ETC gate that has received the identifier for the automobile opens the gate. Consequently, the automobile smoothly passes through the ETC gate. A billing server (not illustrated) in coordination with the ETC gate bills the automobile.

Detecting device 11 and information transmitting device 12 exist inside the automobile. Operating device 13 is the gate of ETC.

Information transmitting device 12 may control the range for transmitting the information according to a management table for the information transmission mode as shown in FIG. 5. The information transmission mode management table retains one or more records including speed (m/second), mode, and range. “Speed (m/second)” indicates moving speed (an example of the moving state) of an automobile. “Mode” indicates a category for changing the transmission range. “Range” indicates distance for transmitting information. That is to say, if the automobile speed is 0 m/second, information transmitting device 12 determines the mode as “0” and transmits information to a range of 1 m; if the automobile speed is 0.1 to 5.0 m/second, the mode is determined as “1” and information is transmitted to a range of 10 m; if the automobile speed is 5.1 m/second to 15.0 m/second, the mode is determined as “2” and information is transmitted to a range of 25 m; if the automobile speed is 15.1 m/second or higher, the mode is determined as “3” and information is transmitted to a range of 100 m. Here, information transmitting part 1203 of information transmitting device 12 can change the range for transmitting the information by changing the electric field intensity.

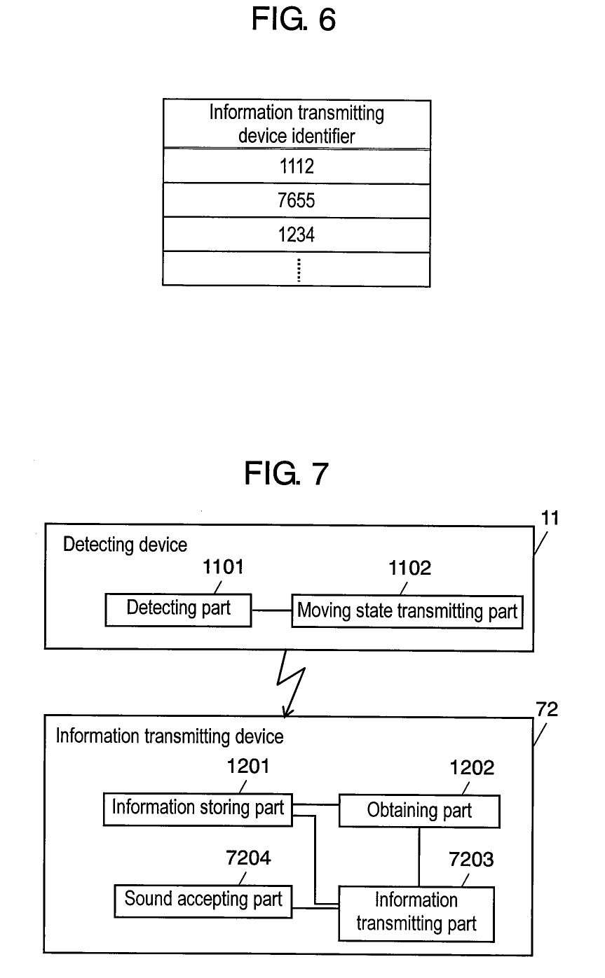

ETC in-vehicle part (information transmitting device 12) is assumed to retain information transmitting device identifier “7655”, which identifies an automobile or ETC in-vehicle part. Authenticating means 13021 of operating device 13 retains the information transmitting device identifier management table shown in FIG. 6. The information transmitting device identifier management table includes one or more information transmitting device identifiers.

In such a case, detecting device 11 regularly detects automobile speed, for example. Then, the ETC in-vehicle unit (information transmitting device 12) obtains the speed. Next, information transmitting part 1203 of the ETC in-vehicle unit obtains range corresponding to speed from the information transmission mode management table of FIG. 5.

Next, information transmitting part 1203 reads information transmitting device identifier “7655” from information storage part 1201 to compose information to be transmitted. The information could be information that includes information transmitting device identifier “7655” and that directs to open an ETC gate. Then, information transmitting part 1203 transmits information including information transmitting device identifier “7655” to a range obtained in the above description.

Next, information receiving part 1301 of operating device 13 receives information including information transmitting device identifier “7655”. Then, operating part 1302 performs authentication according to information transmitting device identifier “7655”. That is, authenticating means 13021 judges whether or not information transmitting device identifier “7655” is retained in the information transmitting device identifier management table shown in FIG. 6. Here, information transmitting device identifier “7655” is retained in the information transmitting device identifier management table shown in FIG. 6, thus resulting in authentication admitted. Then, operating means 13022 opens the ETC gate. The process for opening an ETC gate is one according to a publicly known technique, and thus its detailed description is omitted here. Meanwhile, operating means 13022 transmits billing information including information transmitting device identifier “7655” to a billing server (not illustrated). The billing server performs a given billing process for the ETC in-vehicle unit (or automobile) corresponding to information transmitting device identifier “7655”. The given billing process is one according to a publicly known technique as well, and thus its detailed description is omitted here.

In this embodiment, the range in which an ETC in-vehicle unit (information transmitting device 12) mounted on an automobile transmits information to an ETC gate (operating device 13) changes according to the moving speed of the automobile. Consequently, as the moving speed of the automobile is higher, the ETC gate receives information at greater ranges to open. Still in this embodiment, the moving speed of the automobile is detected by detecting device 11 retained by the automobile, to be sent to information transmitting device 12. Here, information transmitting device 12 regularly fetches the latest speed detected by detecting device 11. However, this operation may be performed when a given condition is met. A given condition includes a case where detecting device 11 detects that the ETC gate is approached within a given range. Such detection is made according to a GPS receiver and map information, for example. The following arrangement may be made. That is, when information is transmitted to operating device 13 once, or when information is transmitted to operating device 13 once and detecting device 11 detects that operating device 13 has received the information, information transmitting device 12 does not transmit information again.

In this embodiment, operating part 1302 performs an authentication process with authenticating means 13021. However, operating part 1302 may omit an authentication process. That is, operating part 1302 may open an ETC gate whenever receiving information.

In this embodiment, the moving state of an automobile is represented by speed. However, other information related to movement such as acceleration may be used. Information transmitting device 12 may change the range for transmitting the information according to the automobile acceleration obtained, to transmit the information.

According to this embodiment hereinbefore, an operating device operates timely that operates according to information received from an information transmitting device moving relatively to the operating device. Here, “moving relatively” includes the case where the information transmitting device is at a stop while the operating device is moving.

Still according to this embodiment, the information transmitting device changes the range for the transmitting information according to a moving state detected by the detecting device, to transmit the information. However, the information transmitting device itself may obtain a moving state of a mobile object. That is, the information transmitting device could be one equipped with an information storage part storing information, an obtaining part for obtaining a moving state of a mobile object, and an information transmitting part that changes range for transmitting the information according to the moving state, to transmit the information.

According to this embodiment, a case where opening an ETC gate is described as an example of operation performed by the operating device. However, the concept of the present invention is applied to various kinds of operation other than the above, such as opening/closing of an automatic door or a garage door, and turning on/off of the switch of an electric/electronic device such as an air conditioner or television set.

Further, the process according to the embodiment may be implemented with software. Still the software may be distributed through downloading or the like, or a recording medium such as a CD-ROM. This situation applies to other exemplary embodiments as well in this patent description.

Here, the software for implementing an information transmitting device according to the embodiment is as follows. That is, this program is one for making a computer execute an obtaining step for obtaining a moving state of a mobile object, and an information transmitting step for changing the range for transmitting the information according to the moving state, to transmit the information stored.

The software for implementing the process of the operating device according to the embodiment is as follows. That is, this program is one for making a computer execute an information receiving step for receiving information from the information transmitting device, and an operating step for operating according to the information received in the information receiving step.

Furthermore, the software for implementing the process of the detecting device according to the embodiment is as follows. That is, this program is one for making a computer execute a detection step for detecting a moving state of a mobile object, and a moving state transmitting step for transmitting the moving state to the information transmitting device.

### SECOND EXEMPLARY EMBODIMENT

FIG. 7 is a block diagram of an information processing system according to the embodiment. The information processing system is equipped with detecting device 11 and information transmitting device 72. Information transmitting device 72, a mobile phone for example, includes information storage part 1201, sound accepting part 7204, obtaining part 1202, and information transmitting part 7203.

Sound accepting part 7204 accepts sound input from the user. Sound accepting part 7204 can be implemented with a microphone and its driver software, for example.

Information transmitting part 7203 changes the transmission range of sound information accepted by sound accepting part 7204 according to a moving state obtained by obtaining part 1202, to transmit the sound information. A transmission destination of sound information is a base station for mobile phones or wireless communication, for example. Here, information transmitting part 7203 usually transmits sound information with information in information storage part 1201 added. Information transmitting part 7203, ideally a wireless communication means, can be implemented with a broadcast receiving means or wired communication means as well.

In this embodiment, information retained by information storage part 1201 is the phone number of a mobile phone, for example.

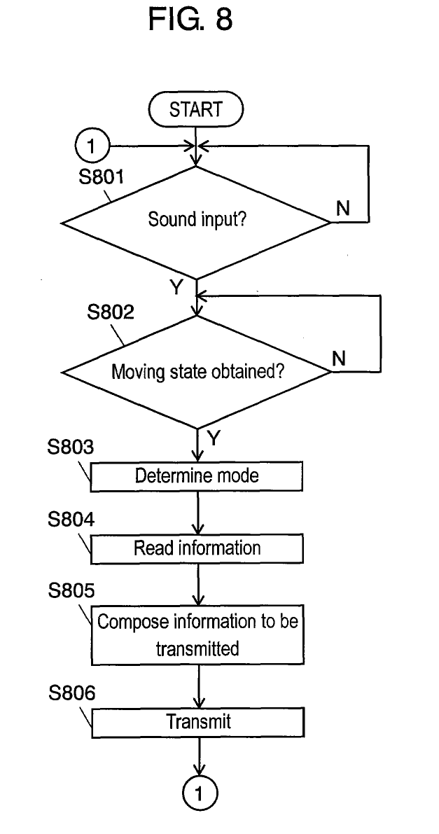

Next, a description is made for the operation of information transmitting device 72 using the flowchart of FIG. 8.
(Step S801) Sound accepting part 7204 judges whether or not sound input has been accepted. If accepted, the flow proceeds to step S802; otherwise, returns to step S801.
(Step S802) Obtaining part 1202 judges whether or not a moving state has been obtained. If obtained, the flow proceeds to step S803; otherwise, returns to step S802.
(Step S803) Information transmitting part 1203 determines the mode for transmitting information, according to the moving state obtained in step S802. This mode is one that determines the range for transmitting the information. That is, the transmission range varies depending on the mode.
(Step S804) Information transmitting part 1203 reads information in information storage part 1201.
(Step S805) Information transmitting part 1203 composes information to be transmitted, usually according to the sound accepted in step S801 and the information read in step S804.
(Step S806) Information transmitting part 1203 transmits the information composed in step S805, according to the mode determined in step S203. The flow returns to step S801.

Here, information transmitting device 72 sound-outputs the sound information received (sound information at the other party of the telephone communication). Such operation is an existing technique and thus its description is omitted.

Hereinafter, a concrete description is made for the information processing system according to the embodiment.

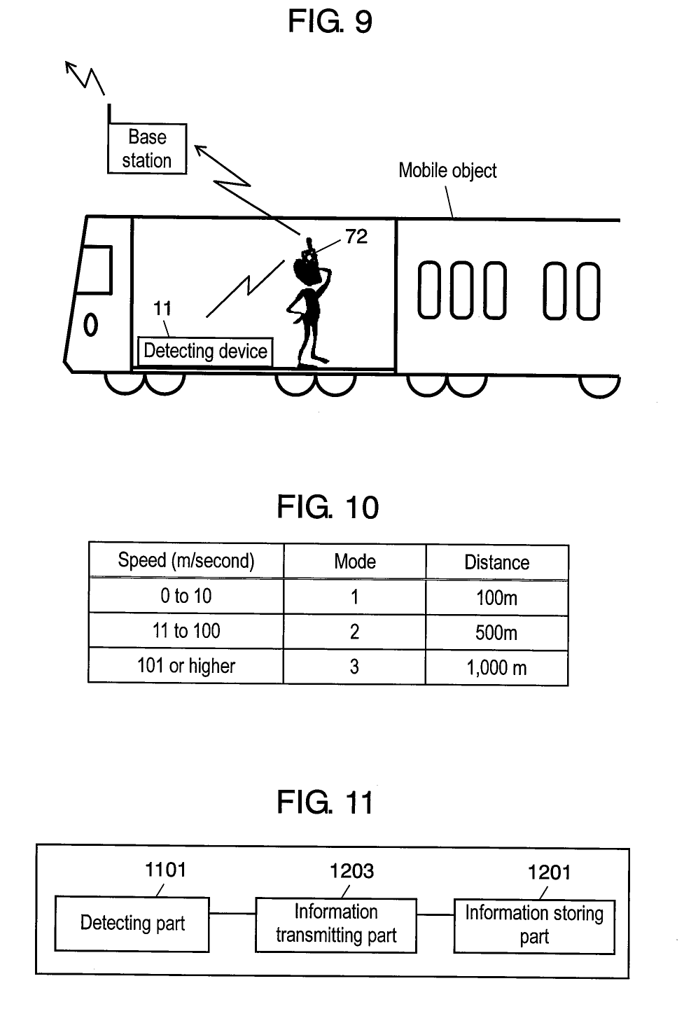

FIG. 9 is a concrete conceptual diagram of the information processing system. In this system, the mobile object is a train, for example. Detecting device 11, placed inside the train, detects the train speed. Information transmitting device 72 is a mobile phone, for example. The user is assumed to be communicating with another user over the mobile phone.

The mobile phone retains the information transmission mode management table shown in FIG. 10. When the train is moving at a speed of 0 m/second to 10 m/second (including the case of being in a stop), information transmitting device 72 determines the mode as “1” and transmits information to a range of 100 m; When the train is moving at a speed of 11 m/second to 100 m/second, information transmitting device 72 determines the mode as “2” and transmits information to a range of 500 m; When the train is moving at a speed of 101 m/second or faster, information transmitting device 72 determines the mode as “3” and transmits information to a range of 1,000 m. Here, information transmitting part 1203 of information transmitting device 12 can change the transmission range by changing the electric field intensity.

For instance, when the user starts sound communication over the mobile phone, detecting device 11 placed in the train detects the train speed. Then, the mobile phone receives information on the train speed. Preferably, a means for transmitting the train speed from detecting device 11 to the mobile phone is a short-range wireless communication means such as Bluetooth (registered trademark), but may be another communication means.

Then, the mobile phone obtains information on the train speed, to change the range for transmitting the information according to the speed. The information transmitted by the mobile phone is a packet including control information in the call control process, stored in information storage part 1201, a phone number (e.g. “09012345678”), and sound information of the user's telephone communication, for example.

Then, the base station of the mobile phone receives the packet sent out from the mobile phone, allowing telephone communication.

This embodiment described hereinbefore provides an information transmitting device and the like that automatically change the range for transmitting the information according to a moving state of a mobile object. Consequently, a long communication range is ensured while moving at high speed, resulting in ensuring time required to completing a communication process. Meanwhile, while moving at low speed, communication with low power consumption is available.

In this embodiment, the description is made for a train as an example of a mobile object. However, a mobile object obviously includes an automobile, motorcycle, aircraft, and ship.

In this embodiment, the information transmitting device may be one other than a mobile phone. Therefore, the information transmitting device does not need to include a sound accepting part.

In this embodiment, the information transmitting device itself may obtain a moving state. In this case, the process performed by the above-mentioned information processing system can be implemented only with the following information transmitting device. FIG. 11 is a block diagram illustrating the assembly of the information transmitting device. The information transmitting device includes detecting part 1101, information storage part 1201, and information transmitting part 1203. Information transmitting part 1203 changes the range for transmitting the information retained in information storage part 1201, according to a moving state (e.g. speed, acceleration) detected by detecting part 1101, to transmit the information. Such a transmission process is performed by information transmitting part 1203.

A mobile phone having the function of such a information transmitting device further includes sound accepting part 7204. In such a case, the mobile phone is to include a mechanism for detecting a moving state, for example.

In this embodiment, the software for implementing an information transmitting device is a following program. That is, this program is one that makes a computer execute an obtaining step for obtaining a moving state of a mobile object, and an information transmitting step for changing the transmission range according to the moving state, to transmit sound information having been input.

In the program in each embodiment described hereinbefore, the transmitting step for transmitting information, the receiving step for receiving information, and the like, do not include a process performed by hardware (a process performed only with hardware) such as a modem or interface card in the transmitting step. Meanwhile, in the program in each embodiment described hereinbefore, the number of computers for executing the program may be one or more. That is, either a centralized or distributed process may be performed.

In each embodiment described hereinbefore, it is obvious that two or more communication means (e.g. information transmitting part) included in one device may be implemented with a physically single medium.

In each embodiment described hereinbefore, each process (each function) may be implemented with a centralized process by a single device (system), or with a distributed process by multiple devices.

The present invention is not limited to the exemplary embodiments described hereinbefore, but various kinds of changes are allowed, and obviously these changes are included in the present invention.

### INDUSTRIAL APPLICABILITY

As described hereinbefore, the information processing system according to the present invention has the advantage in that the range for transmitting the information can be automatically changed according to a moving state, which is useful as a communication system and the like related to a mobile object.

1. An information transmitting device comprising:
an information storage part storing information;
an obtaining part for obtaining a moving state of a mobile object; and
an information transmitting part that changes a range for transmitting the information according to the moving state and transmits the information.

2. The information transmitting device of claim 1, wherein the obtaining part obtains one of speed and acceleration, at which the mobile object moves, as the moving state.

3. The information transmitting device of claim 1, wherein the information transmitting part classifies the moving state into a plurality of levels, changes the transmission range according to each of the levels, and transmits the information.

4. The information transmitting device of claim 1, wherein changing of the range for transmitting the information is implemented by transmitting the information with different electric field intensity.

5. The information transmitting device of claim 1, wherein the information storage part includes an information transmission mode management table, and wherein the information transmitting part refers to the information transmission mode management table according to the moving state having been obtain to determine the transmission range.

6. The information transmitting device of claim 1, further comprising an sound accepting part for accepting sound input from a user, wherein the sound accepting part changes the transmission range according to the moving state, and transmits the sound information having been accepted.

7. The information transmitting device of claim 1, wherein the obtaining part receives movement information, which is transmitted by a detecting device, of the mobile object.

8. The information transmitting device of claim 1, wherein the obtaining part obtains movement information of the mobile object from a recording medium having a receiving function.

9. An information processing system comprising an information transmitting device and an operating device,
wherein the information transmitting device includes:
an information storage part storing information;
an obtaining part for obtaining a moving state of a mobile object; and
an information transmitting part that changes a range for transmitting the information according to the moving state, to transmit the information, and
wherein the operating device includes:
an information receiving part that receives the information from the information transmitting device; and
an operating part that operates according to the information received by the information receiving part.

10. The information processing system of claim 9, further comprising:
a moving state transmitting part for transmitting the moving state;
a detecting part for detecting the moving state of the mobile object.

11. The information processing system of claim 9, wherein the operating part includes:
an authenticating means for authenticating according to the received information; and
an operating means that operates if an authentication result by the authenticating means is authentication admitted.

12. The information processing system of claim 9,
wherein the information storage part includes an information transmission mode management table; and
wherein the information transmitting part refers to the information transmission mode management table according to the moving state having been obtained, and determines the transmission range.

13. The information processing system of claim 9, wherein the operating part performs operation of opening a door or a gate.

14. The information processing system of claim 9, wherein the operating device is an ETC gate, and the operating part performs operation of opening the ETC gate.

15. An information processing system comprising an information transmitting device and a detecting device,
wherein the information transmitting device includes:
an information storage part storing information;
an obtaining part for obtaining a moving state of a mobile object; and
an information transmitting part that changes a range for transmitting the information according to the moving state, to transmit the information, and
wherein the detecting device includes:
a detecting part for detecting the moving state of the mobile object; and
a moving state transmitting part for transmitting the moving state.

16. A mobile phone comprising:
an obtaining part for obtaining a moving state of a mobile object; and
an information transmitting part that changes a transmission range according to the moving state, and transmits sound information having been input.

17. The mobile phone of claim 16, wherein the obtaining part detects one of speed and acceleration, at which the mobile object moves, as the moving state.

18. A program for making a computer execute:
an obtaining step for obtaining a moving state of a mobile object;
a step for selecting a range for transmitting information according to the moving state; and
a step for transmitting one of sound information having been input and information stored in the computer.

19. A program for making a computer execute:
an information receiving step for receiving information from an information transmitting device; and
an operating step that operates according to information related to a moving state received in the information receiving step.

20. The program of claim 19, wherein the operating step includes:
an authenticating sub-step for authenticating according to the information received; and
an operating sub-step that operates if an authentication result in the authenticating step is authentication admitted.
